(19) United States
(12) Patent Application Publication
(10) Pub. No.: US 2024/0103477 A1
(43) Pub. Date: Mar. 28, 2024

(54) METHOD FOR GENERATING A CONTROL PROGRAM FOR AN AUTOMATION SYSTEM AND PROGRAMMING TOOL

(71) Applicant: Beckhoff Automation GmbH, Verl (DE)

(72) Inventor: Ralf Dreesen, Rietberg (DE)

(21) Appl. No.: 18/526,738

(22) Filed: Dec. 1, 2023

Related U.S. Application Data
(63) Continuation of application No. PCT/EP2022/065195, filed on Jun. 3, 2022.

(30) Foreign Application Priority Data
Jun. 4, 2021 (DE) 10 2021 114 449.3

(51) Int. Cl. G05B 19/05; G06F 8/34

(52) U.S. Cl. CPC G05B 19/056; G06F 8/34; G05B 2219/13052

(57) ABSTRACT

The application relates to a method for generating a control program for controlling an automation system, the method comprising:

generating a graphical diagram of the control program according to the graphical programming language ladder diagram LD for Programmable Logic Controllers in a diagram generating step;
generating a data flow graph as a representation of the graphical diagram in a graph generating step, wherein elements of the graphical diagram are represented as nodes and connecting lines between elements of the graphical diagram are represented as edges of the data flow graph; and
generating a version of the control program executable by a programmable logic controller based on the data flow graph in a program generating step.

The application further relates to a programming tool for carrying out the method.

### CROSS-REFERENCE TO RELATED APPLICATIONS

This patent application is a continuation of International Patent Application No. PCT/EP2022/065195, filed Jun. 3, 2022, and entitled METHOD FOR GENERATING A CONTROL PROGRAM FOR AN AUTOMATION SYSTEM, AND PROGRAMMING TOOL, which claims the priority of German patent application DE 10 2021 114 449.3, filed Jun. 4, 2021, and entitled VERFAHREN ZUM ERZEUGEN EINES STEUERPROGRAMMS FUR EIN AUTOMATISIERUNGSSYSTEM UND PROGRAMMIERWERKZEUG, each of which is incorporated herein by reference in the entirety and for all purposes.

The application relates to a method for generating a control program for controlling an automation system and a programming tool for carrying out the method.

### BACKGROUND

Five programming languages are defined in the IEC61131-3 standard for programming control programs for programmable logic controllers PLCs. Among the five defined programming languages are both text-based programming languages and graphical programming languages. One of the graphical programming languages for programming programmable logic controllers is Ladder Diagram LD. The Ladder Diagram LD programming language enables the user to create graphical diagrams for programming control programs for programmable logic controllers. The graphical diagrams are based on the circuit diagrams of relay circuits. Based thereon, elements of the graphical diagrams are referred to as voltage rails, contacts and (relay) coils. Connecting lines between elements of the graphical elements represent a current flow between the elements.

In the interpretation of the graphical diagrams as control programs, the individual elements are associated with variables of the control program. The elements may either be activated or deactivated, with the respective variables being assigned the corresponding values 1 or 0.

In order to convert the graphical diagrams into correspondingly executable control programs, graphical diagrams are usually first converted into text-based representations that are suitable for displaying the information of the graphical diagrams. For this purpose, prior art graphical diagrams are hierarchically structured and divided up into hierarchically ordered units. These units may, for example, consist of individual elements, groups of serially arranged elements or groups of elements arranged in parallel.

However, such hierarchical structuring constitute a strong restriction to the generation of graphical diagrams, since in return exclusively graphical diagrams are possible, which may be expressed in an unambiguous way in corresponding hierarchical structures.

As a result, not all graphical diagrams that meet the requirements of the IEC61131-3 standard may actually be generated in the current state of the art, or they have to be extended and complicated in order to meet the requirements of the hierarchical structures. In particular, the underlying hierarchical structures are a hindrance to changes in existing graphical diagrams, since even small changes in the graphical diagram may require serious structural changes in the underlying hierarchical structures, which may result in complex changes and in some cases complete restructuring of the graphical diagrams in order to take into account the desired changes and also to meet the requirements of the hierarchical structures.

### SUMMARY

An improved method for generating a control program for controlling an automation system and a programming tool for executing the method and a method for controlling an automation system are provided.

### EXAMPLES

A method for generating a control program for controlling an automation system is provided, the method comprising:
generating a graphical diagram of the control program according to the Ladder Diagram LD graphical programming language for Programmable Logic Controllers in a diagram generating step;
generating a data flow graph as a representation of the graphical diagram in a graph generating step, wherein elements of the graphical diagram are represented as nodes and connecting lines between elements of the graphical diagram are represented as edges of the data flow graph; and
generating a version of the control program executable by a programmable logic controller based on the data flow graph in a program generating step.

Hereby, the technical advantage may be achieved that an improved method for generating a control program for controlling an automation system may be provided. The method is based on a programming of control programs using the Ladder Diagram LD graphical programming language defined for programming programs for programmable logic controllers PLC. For this purpose, the method according to the application provides a representation of the graphical diagrams created according to the ladder diagram LD graphical programming language in the form of data flow graphs. The representation of the graphical diagrams by corresponding data flow graphs, in which nodes of the data flow graphs correspond to corresponding elements of the graphical diagrams represented by the data flow graphs and edges of the data flow graphs correspond to connecting lines of the graphical diagrams, allows increased flexibility in the generation of the graphical diagrams for graphical programming of the control programs. In this context, the representation of the graphical diagrams by corresponding data flow graphs serves as a replacement of the representation of the graphical diagrams known from the prior art by corresponding hierarchical structures.

The flexible representation in the form of the data flow graphs may be used in order to generate graphical diagrams that meet the requirements of the Ladder Diagram LD programming language, but which cannot currently be represented by the hierarchical representation in the prior art. Furthermore, the representation by the data flow graphs may be used to generate graphical diagrams that are simplified in complexity compared to the graphical diagrams that may be generated in the prior art, but have identical functionality. By simplifying the graphical diagrams, which, for example, make do with fewer elements and associated with fewer connecting lines, on the one hand the graphical programming and generation of the graphical diagrams may be simplified and as a result of this, faster programming may be provided. On the other hand, the less complex graphical diagrams are easier to read, clearer and thus easier to understand. Moreover, by reducing the complexity of the graphical diagrams, the complexity of the control programs expressed by the graphical diagrams may also be simplified. Such control programs may in turn reduce computing capacity for executing the control programs. In this way, a faster control of automation systems or programmable logic controllers requiring less computing capacity may be achieved by executing corresponding control programs.

A graphical diagram in the sense of the application is a graphical representation generated by graphical programming operations, and according to the definitions of the graphical programming language ladder diagram LD provides a representation of a control program of an automation system or a programmable logic controller.

### BRIEF DESCRIPTION OF THE DRAWINGS

The application is described in more detail with reference to the accompanying figures, which show:

FIGS. 1A-1C are schematic depictions of a graphical diagram according to the programming language ladder diagram LD and a data flow graph;

FIGS. 2A-2D are further schematic depictions of a further graphical diagram according to the programming language ladder diagram LD and a further data flow graph;

FIGS. 3A-3D are further schematic depictions of a further graphical diagram according to the programming language ladder diagram LD and a further data flow graph;

FIGS. 4A and 4B are further schematic depiction of a further graphical diagram according to the programming language ladder diagram LD and a further data flow graph;

FIGS. 5A and 5B are further schematic representation of a further graphical diagram according to the programming language ladder diagram LD and another data flow graph;

FIGS. 6A-6E are schematic depictions of a method for generating a control program for controlling an automation system according to an embodiment;

FIG. 7 is a flowchart of the method for generating a control program for controlling an automation system according to an embodiment;

FIG. 8 is a further flowchart of the method for generating a control program for controlling an automation system according to a further embodiment;

FIG. 9 is a further flowchart of the method for generating a control program for controlling an automation system according to a further embodiment;

FIG. 10 is a further flowchart of the method for generating a control program for controlling an automation system according to a further embodiment; and

FIG. 11 is a schematic depiction of a programming tool according to an embodiment.

### DETAILED DESCRIPTION

For the purposes of the application, a data flow graph is a graph-based representation of the information of a corresponding graphical diagram. The data flow graph comprises a plurality of nodes and of edges connecting the nodes to one another, wherein the nodes are representations of the elements and the edges are representations of the connecting lines of a respective graphical diagram. According to the application, the data flow graph is embodied in such a way that, in addition to the complete information of the respective graphical diagram, a data flow within the graphical diagram is represented by the data flow graph.

For the purposes of the application, an executable version of a control program may be, for example, a binary version of the control program to be executed.

According to an embodiment, the diagram generating step comprises:
receiving graphical programming requests according to the ladder diagram LD graphical programming language in a receiving step, the graphical programming requests comprising adding and/or removing and/or rearranging elements and/or connecting lines of the graphical diagram; wherein the graph generating step comprises:
modifying the data flow graph by adding and/or removing and/or rearranging nodes and/or edges of the data flow graph according to the programming requests in a programming step; and wherein the graph generating step comprises:
adding and/or removing and/or rearranging elements and/or connecting lines within the graphical diagram based on the modifications to the data flow graph and according to the graphical programming requests in a graphical programming step.

The technical advantage of this is that it allows for simplified and efficient programming in accordance with the graphical programming language ladder diagram LD. For this purpose, both the graphical diagrams and the corresponding data flow graphs are modified accordingly based on the graphical programming requests that are available for creating control programs according to the graphical programming language ladder diagram LD.

In this context, modifying includes both the creation of new data flow graphs or, respectively, corresponding graphical diagrams and the modification of existing data flow graphs or corresponding graphical diagrams. By executing the graphical programming requests, both the graphical diagram to be generated or modified and the data flow graph representing the graphical diagram are generated or modified. The data flow graph describes a representation of the information of the graphical diagram underlying the graphical diagram. The structure of the data flow graph underlying the graphical diagram in this context determines the modifying and/or generating possibilities of the graphical diagram. Thus, only graphical diagrams the information of which may be represented in a corresponding data flow graph may be generated or modified.

As stated above, the representation of the graphical diagrams in the form of the data flow graphs may be used to generate graphical diagrams the complexity of which is reduced compared to the prior art, and thus to generate control programs that may be executed with reduced computing capacity.

According to an embodiment, the diagram generating step comprises:
reading a control program programmed in the graphical programming language ladder diagram LD in a reading step;
generating a data flow graph based on the information of the read-in control program in a second graph generating step; and
generating the graphical diagram based on the information of the data flow graph in a displaying step.

As a result the technical advantage may be achieved that a precise modification of already existing control programs, which are programmed according to the graphical programming language ladder diagram LD, is provided. The already existing control programs are read in first and based on the information of the read-in control programs, corresponding data flow graphs and graphical diagrams represented thereby are generated. This provides increased flexibility, as both new control programs may be generated and existing control programs may be modified. By representing the graphical diagrams of the already existing control programs by the data flow graphs according to the application, the already existing control programs may be changed or modified with increased flexibility. The representation by the data flow graphs in this context replaces an original representation by the hierarchical structures. The modifications of the control programs are therefore not restricted by the limitations based on the hierarchical structures of the representations of the graphical diagrams known in the prior art.

According to an embodiment, the graphical programming step and/or the displaying step comprise:
converting the nodes of the data flow graph into elements of the graphical diagram and arranging the elements in a two-dimensional array in a first arranging step;
converting the edges of the data flow graph into connecting lines between elements of the graphical diagram and arranging the connecting lines between the elements of the graphical diagram in a second arranging step, each connecting line having exclusively horizontal and/or vertical components and connecting exclusively two elements.

Hereby the technical advantage may be achieved that based on the representation in form of the data flow graphs an unambiguous representation of the control program to be programmed in form of the graphical diagrams following the requirements of the graphical programming language Ladder Diagram LD is possible. For this purpose, the nodes of the data flow graphs are converted into elements of the respective graphical diagrams and arranged in two-dimensional arrays. As a result, a clear representation of the graphical diagram may be achieved.

Furthermore, the edges of the data flow graphs are converted into corresponding connecting lines between respective elements of the graphical diagrams, wherein the connecting lines between the elements of the graphical diagrams arranged in the two-dimensional arrays exclusively comprise horizontal or vertical components. As a result, the connecting lines meet the requirements of the graphical programming language ladder diagram LD defined in the above-mentioned standard. The unambiguous conversion of the nodes and edges of the data flow graphs into corresponding elements and connecting lines of the graphical diagrams allows for providing graphical diagrams with the lowest possible complexity, which are limited to a minimum number of required elements and connecting lines. In this way, the most efficient control programs may be achieved, which may be executed with the aid of a minimized computing capacity.

According to an embodiment, the two-dimensional array is embodied as a matrix array having a plurality of plot units, wherein each element is arranged in a plot unit, and wherein the connecting lines are arranged at least partially along dividing lines between plot units.

This achieves the technical advantage that the elements and connecting lines of the graphical diagrams may be displayed clearly. As a result, clear and easy to read graphical diagrams may be achieved.

According to an embodiment, the data flow graph is formed as an acyclic graph and comprises a start node and an end node.

This achieves the technical advantage that an unambiguous allocation between generated data flow graphs and corresponding graphical diagrams may be achieved. By embodying the data flow graphs in acyclic form, start and end nodes may be identified, as a result of which an order of the nodes of the data flow graphs may be determined. The start and end nodes may be identified for the representation of the corresponding graphical diagrams as left and right voltage rails of the graphical diagrams, respectively, so that an unambiguous allocation of the individual nodes of the data flow graphs and of the respective elements of the associated graphical diagrams is possible. This allows an unambiguous determination of an associated graphical diagram for each data flow graph, which has the identical information content to the associated data flow graph. This allows for an unambiguous graphical programming of the control program.

According to an embodiment, the graphical programming step and/or the displaying step comprise:
topologically sorting the nodes of the data flow graph and the corresponding elements of the respective graphical diagram in a sorting step, wherein in the topological sorting an order of the nodes of the data flow graph and the corresponding elements of the graphical diagram is determined, and wherein the order corresponds to a distance of each node from the start node; and
arranging the elements of the graphical diagram according to the order of topological sorting in the arranging step.

Hereby the technical advantage may be achieved that clearly arranged and thus easy to read graphical diagrams are made possible. By topological sorting of the nodes of the data flow graphs, in which an order of the nodes is achieved depending on the distances of the respective nodes to the start node of the data flow graphs, and by arranging the elements of the associated graphical diagrams according to the order of the respective elements generated in the topological sorting, graphical diagrams may be generated that are as clear as possible, in which the smallest possible distances between the left and right voltage rails and the respective elements of the graphical diagrams are made possible. As a result of the clarity achieved by this, a simplified graphical programming of the control programs may be achieved. Due to the simplified graphical programming, the time required to create the control program may be minimized. In addition, the clarity of the generated graphical diagrams contributes to the quality of the control programs generated by the graphical programming, which may also be embodied in a clearer and thus more efficient form, as a result of which a computing capacity required for the execution of the corresponding control programs may be reduced.

According to an embodiment, the graphical programming step and/or the displaying step comprise:
optimizing the arrangement of the elements and/or the connecting lines of the graphical diagram with the aid of an optimizing algorithm in an optimizing step, wherein the optimizing comprises minimizing lengths of the connecting lines and/or minimizing distances of elements and/or avoiding intersections of a plurality of connecting lines.

This may achieve the technical advantage that the clarity of the graphical diagrams may be further optimized. This, in turn, again contributes to further facilitating the graphical programming and, associated with this, to reducing the time required to create the control program and to increasing in the efficiency of the control programs generated.

According to an embodiment, edges of the data flow graph are embodied as directed edges, wherein a direction of an edge between two nodes of the data flow graph represents a current flow between the elements of the graph represented by the nodes.

This may achieve the technical advantage that a clear allocation between the data flow graph and the corresponding graphical diagram is possible. This allows for precise graphical programming of the control programs based on the graphical diagrams of the graphical programming language ladder diagram LD and the data flow graphs serving as representation in each case. The directed edges of the data flow graphs allow for a clear interpretation of the data flow starting from the start node of the data flow graph in the direction of the end node of the data flow graph, which corresponds to the current flow within the graphical diagram starting from the left voltage rail in the direction of the right voltage rail.

According to an embodiment, elements of the graphical diagram comprise voltage rails and/or contacts and/or coils and/or functional block instances and/or functional blocks and/or further elements defined according to the ladder diagram LD programming language.

This may achieve the technical advantage that, based on the data flow graphs, unambiguous graphical diagrams may be generated that meet the requirements of the graphical programming language ladder diagram LD. This allows for precise graphical programming of control programs for controlling automation systems.

According to an embodiment, the method further comprises:
storing the data flow graph in a text representation and/or storing the executable version of the control program in an execution file in a storing step.

This may achieve the technical advantage of providing an efficient method for generating control programs. By storing the data flow graphs in text representations, the corresponding data flow graphs may be read in again at later points in time in order to modify the programmed control programs. By storing the executable versions of the control program, the corresponding control programs may be executed at later times on any data processing units.

According to a second aspect, a programming tool for generating a control program for controlling an automation system is provided, the programming tool comprising a graphical editor unit and a translating unit and being configured to carry out the method according to any of the preceding embodiments.

By this, the technical advantage may be achieved that an improved programming tool may be provided, which is arranged to execute the method according to the application for generating control programs with the technical advantages mentioned above.

According to a third aspect, a method for controlling an automation system by executing a control program is provided, wherein the control program is generated by the method for generating a control program for controlling an automation system according to any of the preceding embodiments.

Hereby, the technical advantage may be achieved that an improved method for controlling an automation system may be provided, wherein the control is carried out by executing a control program having the above technical advantages.

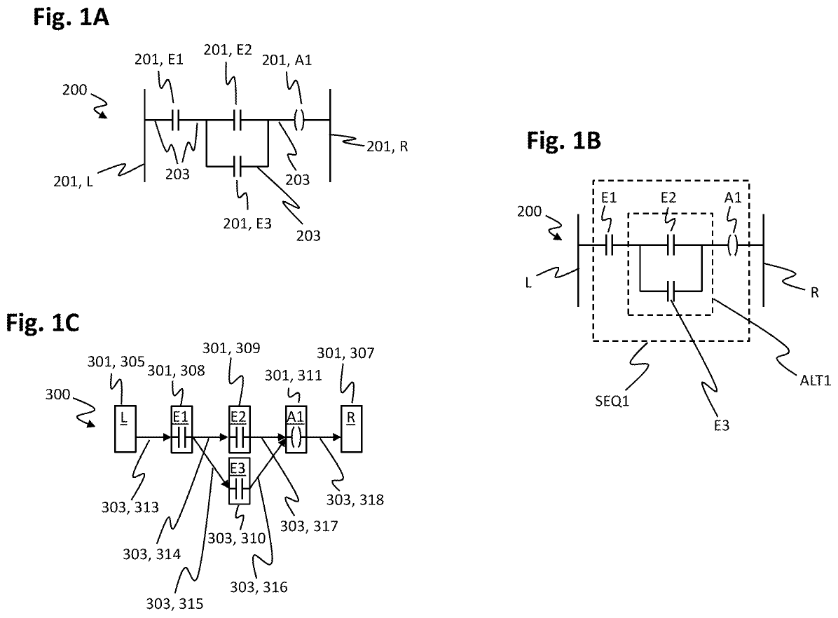

FIGS. 1A-1C show schematic depictions of a graphical diagram 200 and according to the programming language ladder diagram LD and a data flow graph 300.

In the following FIGS. 1A-1C to 5A and 5B, properties and advantages of the method according to the application for generating control programs for controlling automation systems are described with the aid of various graphical examples. For this purpose, in particular the depiction or representation of the graphical diagram 200 created according to the graphical programming language ladder diagram LD in corresponding data flow graphs 300 is described or presented. Moreover, advantages of the representation of the graphical diagrams 200 in the corresponding data flow graph 300 compared to the hierarchical structuring of the graphical diagrams 200 known in the prior art are described.

The graphical diagrams shown in the following FIGS. 1A-1C to FIGS. 5A and 5B are for illustrative purposes only and do not represent actual examples of control programs for automation systems programmed according to the graphical programming language ladder diagram LD. The symbols used in the graphical diagrams 200, as well as in the data flow graphs 300 correspond to the usual nomenclature of the graphical programming language ladder diagram LD. A detailed description of individual elements of the graphical diagrams 200 or of their function or effect within the graphical diagrams or of the control programs expressed by them is omitted. In this connection, reference is made to the above-mentioned standard IEC61131-3 or to descriptions of the graphical programming language ladder diagram LD known in the state of the art.

Graphical depiction A of FIG. 1A shows an exemplary graphical diagram 200 created according to the graphical programming language ladder diagram LD. In accordance with the requirements of the graphical programming language ladder diagram LD, the graphical diagram 200 comprises a plurality of elements 201 interconnected by straight connecting lines 203. In this context, the diagram 200 comprises a left voltage rail L and a right voltage rail R between which a first contact E1, a second contact E2, a third contact E3 and a first coil A1 are arranged connected to one another via corresponding connecting lines 203. In the diagram 200 shown, the second and third contacts E2, E3 are arranged in parallel and this arrangement is in turn arranged in series with the first contact E1 and the first coil A1. The elements 201 of the graphical diagram 200 each comprise inputs and outputs and a connection between two elements 201 via a connecting line 203 is established by arranging the connecting line 203 from an output of one of the elements 201 to an input of the other element 201. Exceptions to this are the left and right voltage lines L, R. There are no connecting lines 203 pointing to the left voltage line L and no connecting lines 203 pointing out of the right voltage line R. Connecting lines 203 have the property that they may have common segments, may overlap, and always run from left to right within the graphical diagram 200.

The elements 201 of the graphical diagram 200 are in the present context associated with variables of a control program, which in turn may assume the values 1 or 0. The allocation of the individual elements 201 with the respective values 1 or 0 corresponds to a switching of the corresponding elements, for example the switching of a switch or a relay coil. Contacts further describe Boolean inputs in which the value 1 corresponds to closing a switch and the value 0 corresponds to opening a switch. A current flow within the diagram corresponds to a closed switch and a value 1 to the left of the switch.

The graphical depiction B of FIG. 1B shows the graphical diagram 200 shown in the graphical depiction A. Furthermore, the graphical depiction B shows a hierarchical structure of the diagram 200 known from the prior art. Following the hierarchical structure, the elements of the diagram 200, in particular the first to third contacts E1, E2, E3 and the first coil A1 are structured to result into a first sequence SEQ1 and a first alternative ALT1.

For the purposes of the application, a sequence SEQ is a sequence of elements or groups of elements within the graphical diagram 200 arranged sequentially or in relation to a current flow within the diagram from left to right one after the other. For the purposes of the application, an alternative ALT is a sequence of elements or groups of elements in parallel or side-by-side arrangement with respect to the current flow.

In the hierarchical structure shown, the first sequence SEQ1 comprises the first contact E1, the first alternative ALT1 and the first coil A1. The first alternative ALT1, on the other hand, comprises the two parallel second and third contacts E2, E3. According to the hierarchical structure shown, the information may be represented as follows.
Structure 1
SEQ1
   Contact E1
   ALT1
   Contact E2
   Contact E3
   Coil A1

In graphical depiction C of FIG. 1C, a representation of the graphical diagram 200 structured according to the present application is shown in a corresponding data flow graph 300. The data flow graph 300 comprises a plurality of nodes 301, each of which is interconnected by a plurality of edges 303. The edges 303 are embodied as directed edges and comprise directions represented by the arrows. A current flow of the graphical diagram 200 between the individual nodes 301 may be represented via the directions of the directed edges 303. The nodes 301 correspond to the elements 201, respectively, and the edges 303 represent the connecting lines 203 of the graphical diagram 200. In analogy to the graphical diagram 200, edges 303 of the data flow graph 300 point from an output of a node 301 to an input of a further node 301. By the direction of the directed edges 303, the data flow within the data flow graph 300 is represented, wherein the data flow corresponds to the current flow within the graphical diagram 200. Edges 303 of the data flow graph 300 are thus created only between nodes 301, which are representations of elements 201 of the graphical diagram 200 between which a direct flow of current is provided in the graphical diagram 200 from the output of one element 201 to the input of the respective other element 201. Since a current flow between two elements 201 within the graphical diagram 200 is always from left to right, the directed edges 303 of the data flow graph 300 may also have a left to right direction.

In this context, the data flow graph 300 comprises a start node 305 and an end node 307. The nodes 301 of the data flow graph 300 may further be arranged in a topological order and the data flow graph 300 comprises, in addition to the start node 305 and end node 307, a first node 308, a second node 309, a third node 310 and a fourth node 311. Thus, the data flow graph 300 corresponds to an acyclic graph having uniquely identifiable start nodes 305 and end nodes 307, characterized in that the start node 305 is connected only to edges 303 that are directed away from the start node 305, while the end node 307 is connected only to edges 303 that are directed toward the end node 307. Data flow graphs 300 with multiple end nodes 307 are conceivable, as well. However, in this case, each end node 307 is uniquely identifiable as an end node. In the data flow graph shown, the start node 305 corresponds to the left voltage rail L and the end node 307 corresponds to the right voltage rail R. The first node 308 corresponds to the first contact E1, the second node 309 corresponds to the second contact E2, the third node 310 corresponds to the third contact E3 and the fourth node 311 corresponds to the first coil A1. The topological sorting of the individual nodes 301 is in this context based on the distance of the individual nodes to the start node 305. The distance of a node to the start node 305 may in this context be defined by a number of nodes 301 arranged in a connection via at least one edge between the respective node and the start node 305. Inductively, a distance of 0 may be assigned to the start node 305, while a distance may be assigned to each further node as a sum of a value 1 and a maximum distance of the nodes arranged directly in front. A topological order is also defined/given on the edges 303 and the data flow graph 300 comprises a first edge 313, a second edge 314, a third edge 315, a fourth edge 316, a fifth edge 317, and a sixth edge 318.

In the shown embodiment, the arrangement of the nodes 301 within the data flow graph 300 corresponds to the arrangement of the elements 201 within the graphical diagram 200, and the data flow graph 300 of the graphical depiction C is a unique representation of the graphical diagram 200 of the graphical depiction A and comprises the identical information content to the graphical diagram 200 shown. The data flow graph 300 may be shown in a different arrangement from that shown. Provided that the topological order of the graph, or of the nodes and edges of the graph, is preserved, all possible arrangements are equivalent and represent the same graphical diagram 200.

A textual representation of the information content of the data flow graph 300 may be shown as follows:
Structure 2
Node 305: L
Node 307: R
Node 308: E1
Node 309: E2
Node 310: E3
Node 311: A1
Edge 313: Node 305, Node 308
Edge 314: Node 308, Node 309
Edge 315: Node 308, Node 310
Edge 316: Node 310, Node 311
Edge 317: Node 309, Node 311
Edge 318: Node 311, Node 307

Edges are in this context defined by ordered pairs of nodes connected by the respective edge. The order of the nodes within the ordered pairs of edges represents the direction of the directed edge.

In the shown text-based representation, the entire information of the data flow graph 300 is represented. The information content of the data flow graph 300 corresponds to the information content of the associated graph 200, and the data flow graph 300 is a unique representation of the graph 200 in the graphical depiction A.

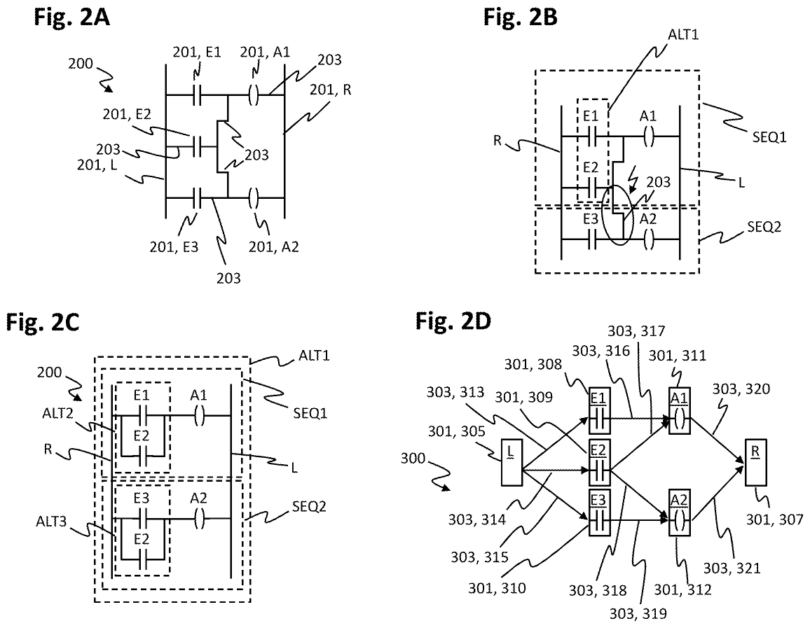

FIGS. 2A-2D show further schematic depictions of a further graphical diagram 200 according to the programming language ladder diagram LD and a further data flow graph 300.

FIGS. 2A-2D show an example of a graphical diagram 200 which cannot be represented according to the hierarchical structure known from the prior art or may only be represented in an increased complexity. The graphical diagram 200 shown in graphical depiction A of FIG. 2A, on the other hand, may be represented by the depiction according to the application with the aid of a data flow graph 300 (FIG. 2D).

The graphical diagram 200 shown in graphical depiction A includes first to third contacts E1, E2, E3 and first and second coils A1, A2 connected between left and right voltage rails L, R, respectively. The first and third contacts E1, E3 are respectively arranged upstream of the first and second coils A1, A2 with respect to a current flow between the left and right voltage rails L, R, while the second contact E2 is arranged adjacent to the first and third contacts E1, E3 with respect to the current flow. In the diagram shown, the second contact E2 is further connected to both the first coil A1 and the second coil A2 by respective connecting lines 203.

Graphical depiction B (FIG. 2B) shows a hierarchical structuring of the graphical diagram 200 of graphical depiction A (FIG. 2A) analogous to the procedure in FIGS. 1A-1C. However, the hierarchical structuring into sequences SEQ and alternatives ALT analogous to the structuring in FIGS. 1A-1C fails in the graphical diagram shown, since due to the connection of the second contact E2 with both the first coil A1 and the second coil A2, no unambiguous structuring is possible, since no unambiguous allocation of the second contact E2 to a sequence or alternative may be found.

In diagram B, an exemplary hierarchical structuring is shown, in which the shown graphical diagram 200 is structured into a first sequence SEQ1 and a second sequence SEQ2 and a first alternative ALT1. The first sequence SEQ1 comprises the first alternative ALT1, thus the first and second contacts E1, E2, and furthermore the coil A1. The second sequence SEQ2 comprises the third contact E3 and the second coil A2. However, due to the marked connecting line 203 between the second contact E2 and the second coil A2, the proposed structuring is not complete, since due to the marked connecting line 203, the second contact E2 would also have to be part of the second sequence SEQ2 comprising the second coil A2. However, since in the shown diagram 200 the second contact E2 occurs only once, a double allocation of the second contact E2 to two different sequences or alternatives is not possible.

Graphical depiction C shows an alternative graphical diagram 200 to the diagram 200 of graphical depiction A. As described above, the hierarchical structuring known from the prior art fails in the representation of the diagram 200 shown in graphical depiction A. To circumvent this, graphical depiction C shows an alternative arrangement of the diagram 200, which comprises the information content of the diagram 200 and thus represents a functional alternative to the diagram 200 of graphical depiction A. The diagram 200 of graphical depiction C shows a second contact E2 in a first instance and a second instance. In Diagram 200 of graphical depiction C, in contrast to the diagrams of graphical depictions A and B, the second contact E2 is indicated in a first instance and a second instance.

Due to the dual arrangement of the second contact E2, the first instance of the second contact E21 is connected to the first coil A1 and the second instance of the second contact E2 is connected to the second coil A2. Furthermore, the first instance of the second contact E2 is arranged in parallel to the first contact E1 while the second instance of the second contact E2 is arranged in parallel to the third contact E3. As a result, the alternative structuring of the diagram 200 of the graphical depiction C corresponds analogously to the diagram 200 of the graphical depiction A.

This allows for a clear hierarchical structuring. For this purpose, the diagram 200 shown is structured into a first alternative ALT1, which comprises a first sequence SEQ1 and a second sequence SEQ2. The first sequence SEQ1 comprises a second alternative ALT2 comprising the first and second contacts E1, E2 arranged in parallel to each other, and the first coil A1. The second sequence SEQ2 comprises a third alternative ALT3 comprising the second and third contacts E2, E3 arranged in parallel to each other, and the second coil A2.

Thus, by the shown alternative structuring of the diagram 200, an unambiguous hierarchical structure consisting of sequences and alternatives may be determined. Furthermore, the alternative structuring of the diagram 200 represents the information content of the graphical diagram 200 of the graphical depiction A and a corresponding control program of the two diagrams of the graphical depictions A and C each has an identical mode of operation. However, a disadvantage of the alternative structuring of the diagram 200 of the graphical depiction C is the double instantiation of the second contact E2. This makes the graphical diagram 200 more complicated than the structuring of the graphical depiction A and comprises an additional element 201. This becomes particularly problematic if instead of single elements complex subdiagrams have to be multiplied. This may increase a complexity of the respective control program based on the graphical diagram 200 of the graphical depiction C, whereby a computational effort for the execution of the respective control program may also be increased due to the additional elements 201, which are required exclusively for the fulfillment of the hierarchical structuring but do not provide any additional informational contribution to the graphical diagram.

Graphical depiction D, on the other hand, shows a data flow graph 300 according to the application as a representation of the graphical diagram 200 of graphical depiction A. In analogy to the data flow graphs of FIGS. 1A-1C, the data flow graph 300 comprises nodes 301 connected to each other via edges 303 between the start and end nodes L, R. The nodes correspond to the elements of the graphical diagram 200 of graphical depiction A. The data flow graph shown thus comprises first to third contacts E1, E2, E3 as well as first and second coils A1, A2. The nodes correspond to the elements of the graphical diagram 200 of graphical depiction A. The data flow graph shown thus includes the first to third contacts E1, E2, E3 as well as the first and second coils A1, A2, and as may be seen in graphical depiction D, duplication of the second contact E2 is not necessary. Referring to the graphical diagram 200 in graphical depiction A, the first to third contacts E1, E2, E3 are respectively connected to the start node 305 representing the left voltage rail L. The first and third contacts E1, E3 are respectively connected to the first and second coils A1, A2, which are respectively connected to the end node 307 representing the right voltage rail R. The second contacts E2 are connected to the first coil A1 and the second coil A2, respectively, via the shown directed edges 303. As may be seen in graphical depiction D, it is not necessary to add additional nodes as was required in the alternative structuring of the diagram 200 of graphical depiction C. The representation of the diagram 200 in the data flow graph 300 thus allows for a simplified representation of the diagram 200, with the information content of the data flow graph 300 resembling the information content of the graphical diagram 200 of the first graphical depiction A. The control program represented by the data flow graph 300 is thus simplified compared to that represented by the graphical diagram 200 of the graphical depiction C, since redundancy due to a duplication of the second contact E2 may be dispensed with. A textual representation of the information content of the data flow graph 300 may be carried out according to the example shown for FIGS. 1A-1C.

The data flow graph 300 shown, in which elements 201 and connecting lines 203 of the graphical diagram 200 are represented by corresponding nodes 301 and directed edges 303, also illustrates the flexibility achieved as a result. Due to the representation by the data flow graph 300, changes within the graphical diagram 200 are easily possible without being restricted due to limitations of the representation used, as is problematic, for example, in the case of the hierarchical structure. If changes are to be made in the graphical diagram 200, for example by deleting or adding elements 201 or changing connections between elements 201, these changes may be applied without restriction in the respective data flow graph 300. Since the directed edges 303 of the data flow graph 300 are defined as ordered pairs, any new nodes 301 and/or edges 303 may be added or existing nodes 301 and/or edges 303 may be deleted, with nodes 301 and edges 303 unaffected by the changes being retained in an unmodified manner, and wherein usually the addition or deletion of nodes 301 entails a corresponding addition or deletion of edges 303. This allows any changes to be made to a graphical diagram 200 without any constraints imposed by the particular representation. However, a cycle freedom of the data flow graph 300 must be maintained at all times during the adjustment.

The following structures 1,2 describe in textual representation the graphical diagram 200 of graphical depiction C (structure 1) and the data flow graph 300 of graphical depiction D (structure 2).
Structure 1
Alt1
   SEQ1
   ALT2
   Contact E1
   Contact E2
   Coil A1
   SEQ2
   ALT3
   Contact E2
   Contact E3
   Coil A2
Structure 2
Node 305: L
Node 307: R
Node 308: E1
Node 309: E2
Node 310: E3
Node 311: A1
Node 312: A2
Edge 313: Node 305, Node 308
Edge 314: Node 305, Node 309
Edge 315: Node 305, Node 310
Edge 316: Node 308, Node 311
Edge 317: Node 309, Node 311
Edge 318: Node 309, Node 312
Edge 319: Node 310, Node 312
Edge 320: Node 311, Node 307
Edge 321: Node 312, Node 307

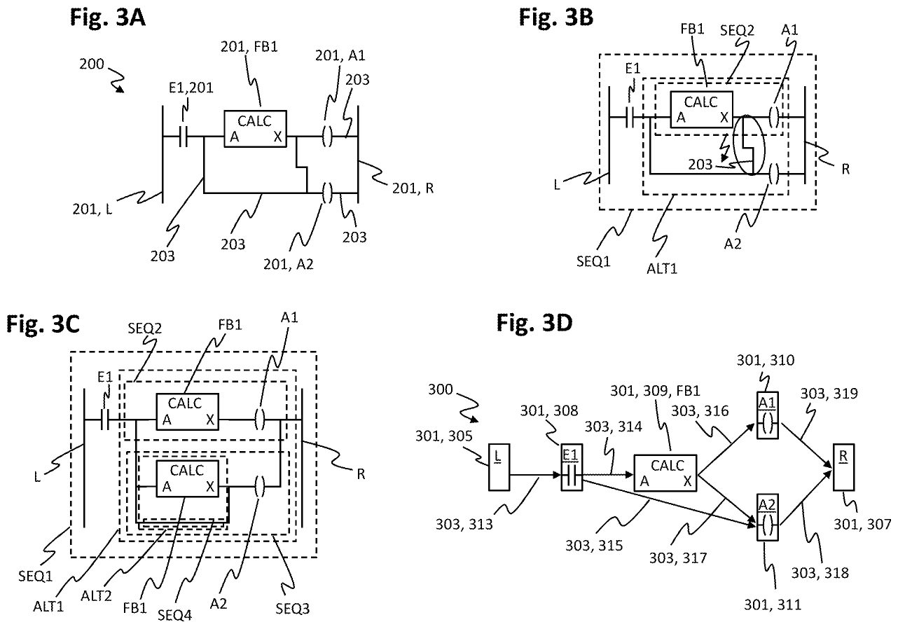

FIGS. 3A-3D show further schematic depictions of a further graphical diagram 200 according to the programming language ladder diagram LD and a further data flow graph 300.

FIGS. 3A-3D show further example of a graphical diagram 200 which is a valid diagram according to the requirements of the graphical programming language ladder diagram LD, but which cannot be represented according to the hierarchical structuring known in the prior art in the form shown in diagram A (FIG. 3A).

The diagram 200 of the graphical depiction A (FIG. 3A) comprises a first contact E1, first and second coils A1, A2 and a call to a first functional block instance FB1 of a functional block CALC. The first functional block instance FB1 may be of the type of any functional block CALC, which processes signals received via a first input A accordingly and outputs corresponding function results via a first output X. In the diagram 200 shown, the call to the first functional block instance FB1 is connected via the first output X to both the first coil A1 and the second coil A2. The first contact E1 is connected to the first input A of the call from the first functional block instance FB1 as well as to the second coil A2.

Analogously with regard to FIGS. 1A-1C and 2A-2D, diagram B (FIG. 3B) shows a failed hierarchical structuring of diagram 200 of graphical depiction A. Analogously with regard to the above discussed problem of the diagram of FIGS. 2A-2D, also in the diagrams of FIGS. 3A-3D both the connection of the call of the first functional block instance FB1 with the first coil A1 and the second coil A2 and the connection of the first contact E1 both with the call of the first functional block instance FB1 and the second coil A2 pose a problem for the unambiguous structuring into sequences and alternatives according to the hierarchical structuring known from the prior art. In the structuring shown, the diagram 200 is structured into a first sequence SEQ1, a second sequence SEQ2 and a first alternative ALT1, wherein the first sequence SEQ1 comprises the first contact E1 and the first alternative ALT1, which in turn comprises the second sequence SEQ2 and the second coil A2, where the second sequence SEQ2 comprises the call of the first functional block instance FB1 and the first coil A1. However, with the connecting line 203 shown between the first functional block FB1 and the second coil A2, a clear allocation, in particular of the call of the first functional block instance FB1, to a sequence or an alternative is not possible.

Analogously with regard to the examples in FIGS. 2A-2D, an alternative structure to the diagram 200 of graphical depiction A is shown in graphical depiction C. The diagram 200 of graphical depiction C represents the same information content as the diagram 200 of graphical depiction A. Here, the diagram 200 of graphical depiction C represents the same information content as the diagram 200 of graphical depiction A, so that the operation of the control programs based on the respective different diagrams 200 of graphical depictions A and C is apparently the same. In this context, the functional block CALC is to be regarded as free of side effects. Analogously with regard to the examples in FIG. 2A-2D, in the alternative structure of diagram 200 of graphical depiction C the previously described ambiguous allocation of the first functional block FB1 is solved by the fact that the first functional block FB1 in the alternative structure is arranged twice in diagram 200.

Arranging the call of the first functional block instance FB1 twice in the alternative structure of the graphical diagram 200 of the graphical depiction C is not to be confused with adding an additional functional block instance to the control program. Instead, arranging the call of the first functional block instance FB1 twice in the graphical diagram 200 is to be understood as executing the behavior of the functional block CALC twice on the functional block instance FB1 within the associated control program.

In the diagram 200 shown in graphical depiction C, the call of the first functional block instance FB1 in each case is connected twice to the first contact E1 and both once to the first coil A1 and once to the second coil A2. Here, the two calls of the first functional block instance FB1 are arranged next to each other analogously to the first and second coils A1, A2 with respect to the current flow. Furthermore, the first contact E1 is connected to the second coil A2. The diagram shown thus appears to correspond mutatis mutandis to diagram 200 of graphical depiction A, and thus appears to represent merely an alternative structuring of the same control program. In the diagram 200 shown, the twofold arrangement of the call of the first functional block instance FB1 allows for a clear hierarchical structuring into sequences and alternatives. The diagram may thus be structured into a first sequence SEQ1 comprising the first contact E1 and a first alternative ALT1. The first alternative ALT1 in turn comprises two sequences SEQ2, SEQ3 arranged in parallel with regard to each other, the second sequence SEQ2 in this context comprises a call to the first functional block instance FB1 and the first coil A1, while the third sequence SEQ3 comprises a second alternative ALT2 and the second coil A2. The second alternative ALT2 again comprises the duplicated call of the first functional block instance FB1 and a fourth sequence SEQ4 arranged in parallel, which itself comprises no further elements but a connecting line arranged in parallel to the duplicated call of the first functional block instance FB1. Due to the dual arrangement of the call of the first functional block instance FB1, the functional block CALC of the call of the first functional block instance FB1 is executed twice when the associated control program is executed. This may result in an increased computational effort based on the duplication of the first functional block FB1, which was required exclusively to allow for the hierarchical structuring, but does not represent any informational added value for the control program. In addition, the behavior of the control program may actually deviate if the execution of the behavior has a side effect, i.e., changes the state of the control program. For example, if the behavior increments a global variable X of the control program, its value would differ after execution of B) and C). Common functional blocks with a side effect are R_TRIG and F_TRIG of IEC61131-3 for edge detection. Duplicating the calls of the instances of these FBs thus indirectly changes the behavior of the program.

The graphical depiction D shows a representation of the graphical diagram 200 according to the application in a corresponding data flow graph 300. The data flow graph 300 comprises all elements of the diagram 200 in graphical depiction A and a double execution of the first functional block FB1 may be avoided. For this purpose, the first contact E1 is connected via a directed edge both to the first input A of the first functional block FB1. Via another directed edge, the first contact E1 is further connected to the second coil A2. The first functional block FB1 is connected to the first coil A1 via the first output X via a directed edge and to the second coil A2 via a further directed edge. This eliminates the need for multiple execution of the functional block CALC of the first functional block FB1, as was required in the structure of the graphical depiction C. The directed edges 303 thus allow for unambiguously assigning the individual nodes 301 to one another without the need to insert additional nodes 301 into the graph to ensure unambiguity. This may reduce a complexity of the control program and possibly a required computational effort to execute the control program. Furthermore, in the case of a side-effect-affected functional block CALC, the behavior does not deviate between A) and D).

The following structures 1,2 describe in textual representation the graphical diagram 200 of graphical depiction C (structure 1) and the data flow graph 300 of graphical depiction D (structure 2).
Structure 1
   SEQ1
   Contact E1
   ALT1
      SEQ2
      ALT2
      Functional block FB1
      SEQ4
      Coil A1
   SEQ3
   Functional block FB1
   Coil A2
Structure 2
Node 305: L
Node 307: R
Node 308: E1
Node 309: FB1
Node 310: A1
Node 311: A2
Edge 313: Node 305, Node 308
Edge 314: Node 308, Node 309
Edge 315: Node 308, Node 311
Edge 316: Node 309, Node 310
Edge 317: Node 309, Node 311
Edge 318: Node 311, Node 307
Edge 319: Node 310, Node 307

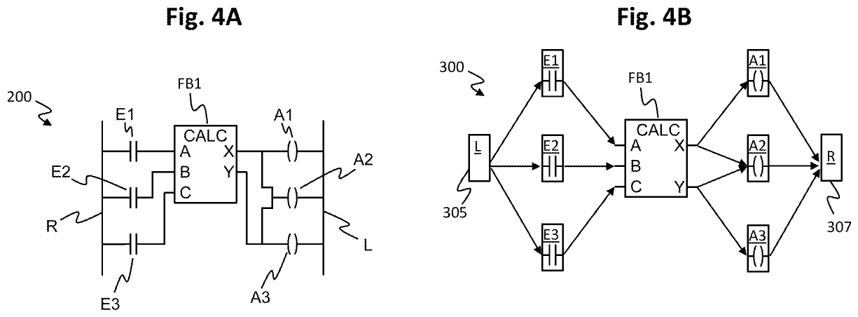

FIGS. 4A and 4B show further schematic depictions of a further graphical diagram 200 according to the programming language ladder diagram LD and a further data flow graph 300.

The examples of a graphical diagrams shown in FIGS. 4A and 4B are in turn permissible according to the rules of the graphical programming language ladder diagram LD, however, following the structuring rules of the prior art, similar to the examples in FIGS. 2A-3D and 3A-3D, it cannot be displayed. The diagram 200 shown in graphical depiction A comprises, in addition to the left and right voltage rails L, R, first to third contacts E1, E2, E3, first to third coils A1, A2, A3 and a call to a first functional block instance FB1 with a functional block CALC to be executed. The first to third contacts E1, E2, E3 are each arranged in parallel relative to the current flow and are each connected to a first input A, a second input B or a third input C of the call to the first functional block instance FB1. The first to third coils A1, A2, A3 are also arranged adjacent to one another, the first coil A1 being connected to a first output X of the call to the first functional block instance FB1 and the third coil A3 being connected to a second output Y of the call to the first functional block instance FB1. The second coil A2 is connected to both the first output X and the second output Y of the call to the first functional block instance FB1. In analogy to the examples shown with respect to FIGS. 2A-2D and 3A-3D, due to the dual connection of the second coil A2 to the first and second outputs X, Y of the call of the first functional block instance FB1, the diagram 200 of the graphical depiction A cannot be uniquely structured into sequences and alternatives according to the hierarchical structure. Furthermore, the plurality of inputs and outputs of the first functional block FB1 prevent an unambiguous representation of the diagram 200 in corresponding hierarchical structures.

Contrary to the examples shown for FIGS. 2A-2D and 3A-3D, no alternative representation is shown in FIGS. 4A and 4B. Such an alternative representation is not possible for the graphical diagram 200 shown in FIGS. 4A and 4B without a number of modifications. The graphical diagram 200 shown in graphical depiction A, which is a permissible graphical diagram according to the rules of programming language ladder diagram LD, may be represented in a hierarchical structuring without modifications, for example additional Boolean operators at the inputs A, B, C of the first functional block FB1.

However, a representation as a data flow graph is easily possible as shown in graphical depiction B.

In deviation from examples of FIGS. 1A-1C to 3A-3D, the following does not include a further description of an alternative graphical diagram 200 and the corresponding hierarchical structure. Instead, graphical depiction B shows a data flow graph 300 according to the application for the graphical diagram 200 of graphical depiction A.

The data flow graph 300 is suitable for unambiguously representing the diagram 200 of the graphical depiction A without having to insert additional elements or nodes for this purpose. The data flow graph 300 thus exclusively comprises the elements of the diagram 200 of the graphical depiction A and all elements are exclusively listed in the data flow graph 300.

The first to third contacts E1, E2, E3 are respectively connected to the start node 305 and the first to third terminals A, B, C of the call to the first functional block instance FB1. The first to third coils A1, A2, A3 are each simply connected to the end node 307, the first coil A1 being connected to the first output X and the third coil A3 being connected to the second output Y of the first functional block FB1. The second coil A2, on the other hand, is connected to both the first and the second output X, Y of the call to the first functional block instance FB1. This provides a simplified representation of the graph 200 of the graphical depiction A compared to the prior art, with the full information content of the graph 200 being clearly represented by the data flow graph 300.

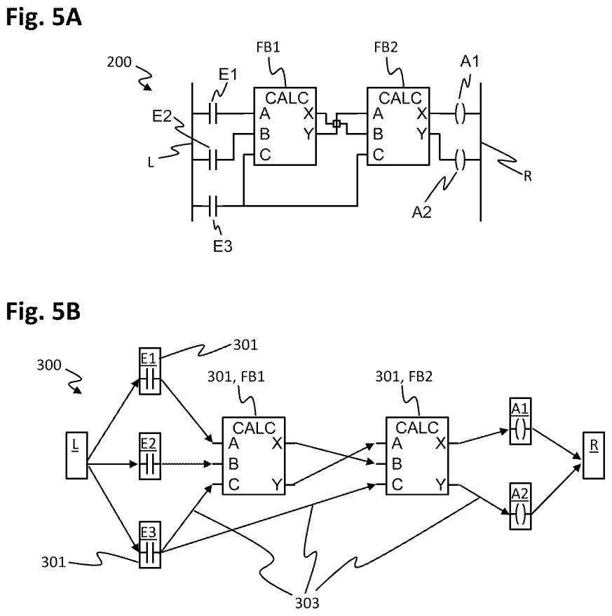

FIGS. 5A and 5B show further schematic depictions of a further graphical diagram 200 according to the programming language ladder diagram LD and a further data flow graph 300.

FIGS. 5A and 5B show further examples of a graphical diagram 200 which is permissible according to the rules of the graphical programming language ladder diagram LD, but which cannot be represented unambiguously according to the structuring rules of the prior art.

The diagram 200 of the graphical depiction A includes first to third contacts E1, E2, E3, a call to a first functional block instance FB1, a call to a second functional block instance FB2, and first and second coils A1, A2. The first to third contacts E1, E2, E3 are arranged adjacent to one another with respect to current flow and are respectively simply connected to first to third terminals A, B, C of the call of the first functional block instance FB1. The first to second coils A1, A2 are respectively arranged side by side and connected to first to second outputs X, Y of the call of the second functional block instance FB2. The calls to the first and second functional block instances FB1, FB2 are respectively connected to each other by connecting the first output X of the call to the first functional block instance FB1 to the second input B to the call of the second functional block instance FB2 and the second output Y to the call of the first functional block instance FB1 to the first input A of the call to the second functional block instance FB2. Moreover, the third contact E3 is connected to the third input C of the call to the second functional block instance FB2. Also due to the crossed connection of the calls of the first and second functional block instances FB1, FB2 to each other, a structuring of the diagram 200 into sequences and alternatives following the rules of hierarchical structuring of the prior art is not clearly possible. Following the above examples, an alternative structure of the diagram 200 would thus have to be created for this purpose, in that multiple arrangements of the calls to the first and/or second functional block instances FB1, FB2 are executed. However, since each call to the second functional block instance FB2 would require values for the ports A, B and C, auxiliary variables would have to be introduced for a hierarchical structuring. As a result, such a connection would not be expressible with the graphical means of the ladder diagram LD language, which would make the diagram difficult to read. The double arrangement of the mentioned elements increases a complexity of the graphical diagram and the corresponding control program. Furthermore, the multiple arrangement of the calls to the functional block instances FB1, FB2 causes a multiple execution of the functional block CALC of the functional block instances FB1, FB2 during the execution of the respective control program. As a result, additional computing steps must be accomplished during the execution of the control program, which is caused exclusively on the restricting hierarchical structuring for the representation of the graphical diagram and thus unnecessarily increases a computing capacity required for the execution of the control program.

Alternatively, a representation of the graphical diagram 200 according to a data flow graph 300 according to the application is shown in the graphical depiction B. Here, the data flow graph 300 exclusively comprises the elements of the graphical diagram 200 of the graphical depiction A and additional or multiple representations of the elements are not necessary. By connecting the individual nodes 301 of the data flow graph 300 with individual directed edges 303, any connections of the individual nodes may be implemented. Among other things, the crossed connection of the first and second functional block instances FB1, FB2 may be easily implemented by corresponding directed edges 303 extending respectively between the first and second outputs X, Y of the call to the first functional block instance FB1 and the corresponding first and second inputs A, B, of the call to the second functional block instance FB2. Furthermore, the third contact E3 may easily be connected via two separate directed edges both once to the third input C of the call of the first functional block instance FB1 and once to the third input C of the call of the second functional block instance FB2. Since the data flow graph according to the application is not subject to the hierarchical structuring of the prior art, multiple executions of the elements, as required in the examples of the prior art shown above, are therefore not necessary. An unambiguous textual representation according to the example shown with respect to FIGS. 1A-1C may be made by carrying out a topological sorting of the individual nodes and an unambiguous allocation of the edges 303 as ordered pairs of the nodes 301 connected by the respective edges 303.

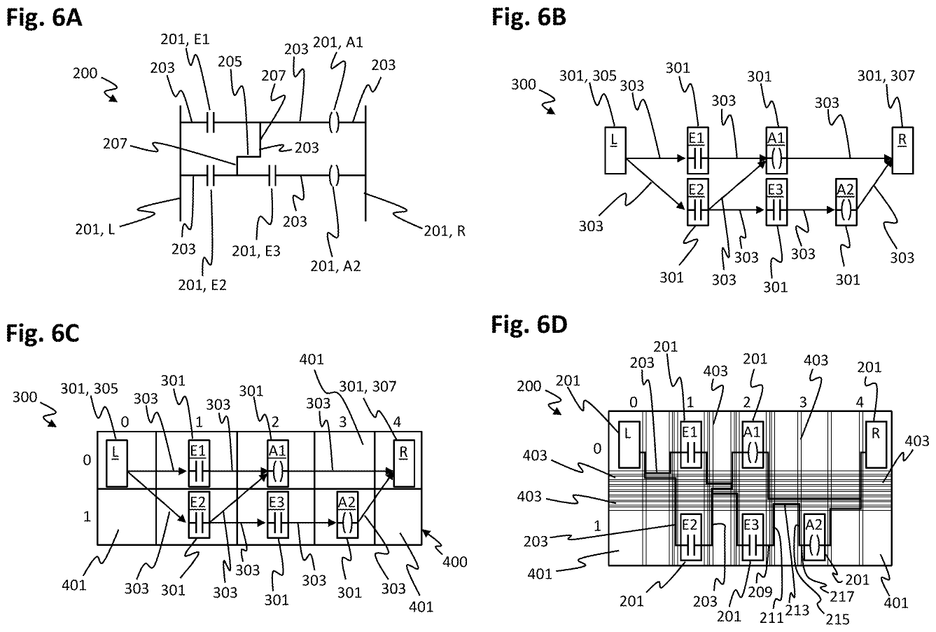

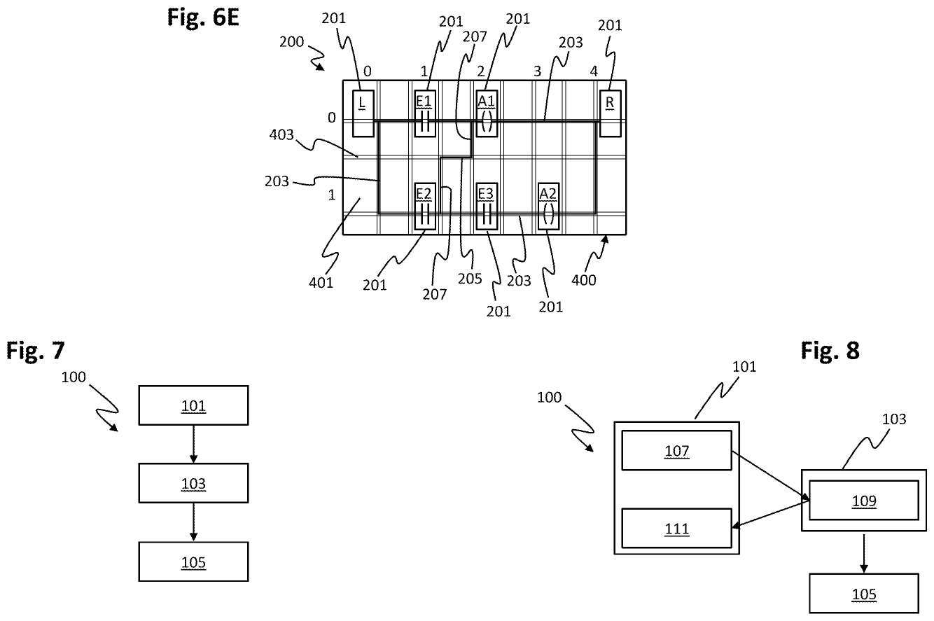

FIGS. 6A-6E show schematic depictions of a method for generating a control program for controlling an automation system according to an embodiment.

FIGS. 6A-6E show graphical depictions of an execution of the method according to the application for generating a control program for controlling an automation system. FIGS. 6A-6E show with the aid of the various graphical depictions A to E how, according to the method according to the application, based on a data flow graph, a corresponding synonymous representation of an associated graphical diagram takes place according to LD by executing various method steps. In the following explanations, the nomenclature introduced in FIGS. 1A-1C to 5A and 5B is used with respect to both the graphical diagrams and the data flow graphs, and no further description is given below.

In analogy to the examples of FIGS. 1A-1C to 5A and 5B, the graphical explanation of the method according to the application is also made on an arbitrary example, which is not intended to serve as a limitation of the present application. As already described above, the representation of the graphical diagrams according to the application by data flow graphs according to the application is not subject to the limitations known from the prior art. The measures for generating a control program according to the method according to the application described below on the basis of the exemplary graphical diagram 200 of the graphical depiction A of FIG. 6A may thus be applied to any graphical diagrams which are permissible according to the rules of the graphical programming language ladder diagram LD.

In the example shown, the graphical diagram 200 of the graphical depiction A includes first to third contacts E1, E2, E3 and first and second coils A1, A2 arranged between left and right voltage rails L, R, respectively. The first contact E1 and the first coil A1 are each arranged one behind the other with respect to current flow, while the second contact E2, the third contact E3 and the second coil A2 are each arranged one behind the other with respect to current flow. With the aid of a further connecting line 203, the second contact E2 is further connected to the first coil A1. In the following embodiment, the diagram 2 shown in diagram A represents a graphical diagram to be obtained by carrying out the method according to the application. This may be carried out, for example, based on corresponding graphical input requests during a graphical programming process. Alternatively, the desired graphical diagram 200 may be generated by reading in an existing graphical diagram and performing appropriate conversion steps, which are performed in the following embodiment.

In order to generate the control program, a data flow graph 300 is first created based on either the graphical programming requests or the read-in, textual information of the pre-existing control program. According to the embodiments of FIGS. 1A-1C to 5A and 5B, the data flow graph 300 comprises a start node 305, an end node 307, and a plurality of nodes 301 arranged therebetween, each of which is interconnected by respective edges 303. The data flow graph 300 shown here comprises all the elements required to represent the desired graphical diagram 200 and comprises the first to third contacts E1, E2, E3 and the first and second coils A1, A2. The first contact E1 is in this case serially connected to the first coil A1, while the second contact E2 is serially connected to the third contact E3, which in turn is serially connected to the second coil A2, the second contact E2 being further connected to the first coil A1.

The generation of the data flow graph 300 may be carried out according to the graphical programming requests in which the addition or removal of various elements of the desired graphical diagram 200 are carried out. For this purpose, a node 301 and an edge 303 of the data flow graph 300 may be assigned to each element 201 and each connecting line 203 of the graphical diagram 200, respectively. In this case, the edges 303 each run from an output of a node 303 to an input of a further node 303 and are each directed in a direction starting from the start node 305 in the direction of the end node 307. An edge 303 is created at the precise time when, in the graphical diagram 200, a corresponding connecting line runs from an output of a corresponding element 201 to the input of a further element 201, and a direct current flow can thus run between the two elements 201 in the direction of the right voltage bar R. In this context, the corresponding graphical programming requests may be directly translated into corresponding modifications of the data flow graph 300 by removing or adding nodes 301 and/or edges 303 accordingly. Alternatively, the data flow graph 300 may be generated based on a textual representation according to the examples given in FIGS. 1A-1C. For this purpose, for example, the textual representations according to the prior art, in which a hierarchical structuring into sequences and alternatives is carried out, may be converted into corresponding textual representations, in which the individual elements are represented as nodes and the connecting lines as directed edges of the data flow graph. The textual representation of a data flow graph 300 may also be directly converted into a corresponding data flow graph, by creating the nodes 303 and the edges 303.

According to a further method step, a topological sorting with depth determination of the nodes of the data flow graph 300 may be carried out and the data flow graph or the nodes 301 of the data flow graph 300 may be arranged in a two-dimensional array 400 as shown in graphical depiction C, wherein each node 301 is arranged in a corresponding plot unit 401 of the two-dimensional array 400, wherein the array 400 may be grid-shaped. A node having a distance i is thereby arranged in the j-th column with j>=i. In this context, the depth of a node 301 describes a number of nodes 301 arranged between the start node 305 and the respective node 301 via a corresponding connection to both. The topological sorting, in which an order of the nodes of the data flow graph 300 is determined is based on the distance of each node 301 from the start node 305 of the data flow graph, respectively. By topologically sorting the data flow graph 300 for or over each node 301, a path starting from the start node 305 to the end node 307 may be found in which none of the directed edges 303 of the path are directed toward or traversed in the direction of the start node 305.

In a further method step, the data flow graph 300 of graphical depiction C is subsequently converted into a corresponding graphical diagram 200, which is shown in graphical depiction D. In this context, all nodes 301 of the data flow graph 300 are converted into corresponding elements 201 of the graphical diagram 200, wherein the array 400 embodied as a grid and the position of the nodes 301 within it are taken over. In addition, the directed edges 303 of the data flow graph 300 are converted into corresponding connecting lines 203 of the graphical diagram 200, the connecting lines 203 having exclusively horizontal or vertical components. The connecting lines 203 are arranged in such a way that they connect those elements 201 the corresponding nodes 301 of which are connected by directed edges 303 of the data flow graph 300. In this context, the individual elements 201 of the graphical diagram are in each case arranged in individual plot units 401 of the two-dimensional array 400. The connecting lines 203 consisting of horizontal or vertical components are further arranged on dividing lines 403 of the two-dimensional array 400, by which adjacent plot units 401 are separated from each other.

In the embodiment shown, each connecting line 203 comprises a respective horizontal starting component 209, a first vertical component 211, a horizontal center component 213, a second vertical component 215, and a horizontal input component 217. In graphical depiction D, for reasons of clarity, the corresponding components are marked with corresponding reference numerals only for the connecting line between the third contact E3 and the second coil A2. In this context, the horizontal starting component 209 is connected to the output of the third contact E3, while the horizontal input component 217 is connected to the input of the second coil A2. The first and second vertical components 211, 215 are each arranged on a vertical parting line 403 of the two-dimensional array 400. The horizontal center component 213 is again arranged on a horizontal parting line 403 of the two-dimensional array 400.

In the embodiment shown, the two-dimensional array 400 includes a plurality of horizontal separating lines 403, each of which is disposed in a central region of the two-dimensional array 400 and separates two superimposed rows of plot units 401. In the embodiment shown, the two-dimensional array 400 comprises eight horizontal separating lines 403 in such a way that one horizontal separating line 403 is provided for each of the eight connecting lines 203. The horizontal center components 213 of the eight different connecting lines 203 may be individually arranged on a horizontal parting line 403. Additionally, the two-dimensional array 400 comprises a plurality of vertical separating lines 403 such that the first and second vertical components 211, 215 of the different connecting lines 203 may be exclusively arranged on a vertical separating line 403.

As an alternative to the graphical depiction D, correspondingly differently structured two-dimensional arrays 400 may be generated for differently structured graphical diagrams 200 or differently structured data flow graphs 300. For example, these may comprise a plurality of superimposed rows of plot units 401 and may include different numbers of vertical and horizontal dividing lines 403.

As an alternative, the nodes 301 may be placed according to other methods, provided that when there is an edge 303 between two nodes 301, the exit of the preceding node 301 is to the left of the entrance of the succeeding node 301.

In a further method step, an optimization is subsequently carried out based on the arrangement 400 of graphical depiction D, in which distances between elements 201 and/or lengths of connecting lines 203 are minimized and/or crossings of connecting lines 203 are avoided. Graphical depiction E shows the graphical diagram 200 resulting from the optimization. Compared to the graphical diagram 200 of graphical depiction D, in particular the lengths of connecting lines 203 are reduced. Connecting lines 203 connecting elements 201 in each case from an input of one element 201 to an output of the other element 201, which are arranged within the same row of plot units 401, are reduced to straight horizontal connecting lines 203 in the course of the optimization by reducing the first and second vertical components 211, 215 to zero. Similarly, for the connecting line between the left voltage rail L and the second contact E2, the second vertical component 215 has been reduced to zero, while for the connecting line 203 between the second coil A2 and the right voltage rail R, the first vertical component 211 has been reduced to zero. The graphical diagram 200 optimized in this way is thus clearly represented and has only connecting lines 203 which have only horizontal components 205 and vertical components 207, respectively. The graphical diagram 200 thus generated corresponds to the desired diagram 200 of graphical depiction A and is clearly represented by the data flow graph 300 of graphical depiction B.

FIG. 7 shows a flowchart of the method 100 for generating a control program for controlling an automation system, according to an embodiment.

The method 100 according to the application for generating control programs for controlling automation systems is applicable to the examples of graphical diagrams 200 according to the graphical programming language ladder diagram LD and the data flow graphs 300 according to the application shown above.

In order to generate a control program for controlling an automation system, a graphical diagram 200 of the control program is first generated in a diagram generating step 101 according to the graphical programming language ladder logic LD for programmable logic controllers PLC. The graphical diagram 200 comprises a plurality of elements 201, each of which is interconnected by connecting lines 203. The elements 201 herein comprise at least a left voltage rail L and a right voltage rail R and a plurality of elements 201 arranged between the left and right voltage rails L, R. The elements 201 arranged between the voltage rails L, R may in this context comprise contacts, coils, calls to functional block instances, functions or other elements defined in the guidelines for the graphical programming language ladder diagram LD. In accordance with the examples shown above, the connecting lines 203 may consist exclusively of horizontal components 205 and vertical components 207.

In a graph generating step 103, a data flow graph 300 is further generated as a representation of the graphical diagram 200 of the control program to be generated. The data flow graph 300 comprises a plurality of nodes 301 interconnected by directed edges 303. The data flow graph 300 includes at least a start node 305 and an end node 307, the start node 305 representing the left voltage rail L of the graphical diagram 200, while the end node 307 represents the right voltage rail R of the graphical diagram 200. A plurality of nodes 301 is arranged between the start and end nodes 305, 307, each representing the elements 201 of the graphical diagram 200. According to the example discussed with respect to FIGS. 1A-1C, the directed edges 303 are defined as ordered pairs of the two nodes 301 connected by the respective directed edge 303, and correspond to connecting lines 203 of the graphical diagram 200. Thus, an edge 303 between two nodes 301 of the data flow graph 300 is to be inserted when the graphical diagram 200 comprises, between the elements 201 represented by the two nodes 301, a connecting line 203 extending between the output of one element 201 and the input of the other element 201, the connecting line 203 representing a direct flow of current between the two elements 201 in a left-to-right direction. In this context, an order of the entries of the ordered pair specifies the direction of the respective edge 303. The diagram generating step 101 and the graph generating step 103 may be carried out either temporally one after the other or temporally simultaneously. Simultaneously is to be understood here in such a way that during the creation of the graphical diagram 200 a corresponding representation is created as a data flow graph. A conversion of elements or connecting lines of the graphical diagram 200 into corresponding nodes 301 and edges 303 of the data flow graph 300 takes place here obviously temporally after the creation in the graphical diagram 200 during programming.

The data flow graph 300 may be formed as an acyclic graph and may include a start node 305 and an end node 307. Here, the edges 303 of the data flow graph 300 are embodied as directed edges and may be represented as ordered pairs of nodes 301, wherein the order of the nodes 301 listed in the ordered pair defines the direction of the respective edge 303.

In a program generating step 105, a corresponding control program for controlling a programmable logic controller is subsequently generated based on the data flow graph 300.

As shown in the examples above, the data flow graph 300 is a unique representation of the associated graphical diagram 200 and comprises the identical information content of the graphical diagram 200. A textual representation of both the graphical diagram 200 and the data flow graph 300 may be effected according to the embodiment shown for example in FIGS. 1A-1C. The elements 201 of the graphical diagram 200 or the nodes 301 of the data flow graph 300 may correspond to variables of the control program and accordingly assume the values 1 or 0.

FIG. 8 shows a further flowchart of the method 100 for generating a control program for controlling an automation system according to a further embodiment.

The embodiment of the method 100 according to the application shown in FIG. 8 is based on the embodiment in FIG. 7 and comprises all the method steps shown there. Insofar as these remain unchanged in the following embodiment, a renewed detailed description is dispensed with.

In the embodiment shown, the diagram generating step 101 comprises receiving graphical programming requests according to the graphical programming language ladder diagram LD in a receiving step 107. The graphical programming requests describe a programming operation of a user and may comprise adding and/or removing and/or rearranging elements 201 and/or connecting lines 203 of the graphical diagram 200. The rearranging here describes that of connections between elements 201 of the graphical diagram 200.

According to a graphical programming process, desired graphical diagrams 200 of a control program to be programmed may thus be created by a user, for example within a corresponding graphical editor according to graphical programming tools known in the prior art for the graphical programming language ladder diagram LD by adding and/or removing and/or rearranging elements 201 and/or connecting lines 203.

In the embodiment shown, the graph generating step 103 comprises a programming step 109. In the programming step 109, the corresponding data flow graph 300 is modified by adding and/or removing and/or rearranging the nodes 301 and/or the edges 303 of the data flow graph 300 according to the programming requests made. A rearrangement of the nodes 301 in this context describes a redesign of the connections of at least one node 301 with further nodes 301 within the data flow graph 300. A rearranged data flow graph thus comprises at least one edge 303 between two nodes 301 that were not connected in the original data flow graph 300, and/or is reduced by at least one edge 303 that represented a connection between two nodes 301 in the original data flow graph 300.

Each executed programming request that removes, adds, or rearranges a corresponding element 201 and/or connecting line 203 within the graphical programming tool makes a corresponding modification to the data flow graph 300 representing the respective graphical diagram 200. Thus, when elements 201 or connecting lines 203 of the graphical diagram 200 are removed by the graphical programming tool, a corresponding removal of the nodes 301 or edges 303 representing the elements 201 or connecting lines 203 within the data flow graph 300 is carried out. As elements are added or arranged, the data flow graph 300 is adjusted accordingly.

The data flow graph 300 may thus be created or modified simultaneously to the graphical programming process within the graphical programming tool by which the respective graphical diagram 200 is created or modified, in a subordinate level, for example of the graphical programming tool, as an additional representation of the graphical diagram 200. In this context, the modifications carried out in the graphical diagram 200 by the graphical programming process are only minimally constrained by the rules underlying the data flow graph 300, so that modifications may be made to the graphical diagram 200 almost without restriction as long as they are in accordance with the rules defined with regard to the programming language ladder diagram LD. The only significant restriction imposed by the representation by a data flow graph is the cycle freedom of the graph, which must be guaranteed at all times.

Thus, the representation of the graphical diagram 200 by the data flow graph 300 is almost without limitation compared to the hierarchical structure known in the prior art and, as a result, has a high flexibility, as illustrated by the examples of FIGS. 2A=2D to 5A and 5B.

In the embodiment shown, the diagram generating step 101 further comprises a graph programming step 111. In the graph programming step 111, elements 201 and/or connecting lines 203 of the graph 200 are added and/or removed and/or rearranged within the graph 200 based on the modifications to the data flow graph 300 and in accordance with the graph programming requests.

Thus, in the graphical programming process, graphical programming requests are first created by making desired modifications within the graphical programming tool. Based on these graphical programming requests, modifications are made to the data flow graph 300 serving as a representation of the respective graphical diagram 200, provided that the graphical programming requests conform to the structural requirements of the data flow graph 300. The desired modifications that are executable according to the structural requirements of the data flow graph 300 are subsequently implemented within the graphical diagram 200, so that desired modifications based on the targeted graphical programming requests of the graphical diagram 200 to be generated are allowed for.

As described above, the representation of the graphical diagrams 200 by the corresponding data flow graphs 300 imposes fewer restrictions in the generation of graphical diagrams 200, so that graphical diagrams 200 may be generated by the method 100 according to the application and the data flow graphs 300 according to the application as a representation of the graphical diagrams 200, which cannot be realized according to the current state of the art and the hierarchical structuring as a representation of the graphical diagrams 200 prevailing therein. Furthermore, due to the simple structure of the data flow graphs 300, any kind of modifications may be carried out within already existing graphical diagrams 200 without having to make substantial changes to the graphical diagrams 200 for this purpose. Additionally, the representation by data flow graphs may simplify the associated graphical diagrams 200. For example, if changes to a graphical diagram 200 have resulted in elements that do not allow a continuous current flow between the left and right voltage rails L, R, because these are, for example, only connected to further elements via either an input or an output, when converted to the data flow graph, these elements may be removed so that no superfluous elements or nodes are included in the graphical diagram 200 as well as in the data flow graph. On the other hand, if elements are removed from the graphical diagram 200 as a result of changes to the graphical diagram 200, any unnecessary edges 303 that do not have a direct connection to nodes 301 of the data flow graph 300 are also automatically removed in the data flow graph 300. This simplifies the corresponding graphical diagram 200 by removing all connecting lines that do not represent a direct connection between elements 201 as well.

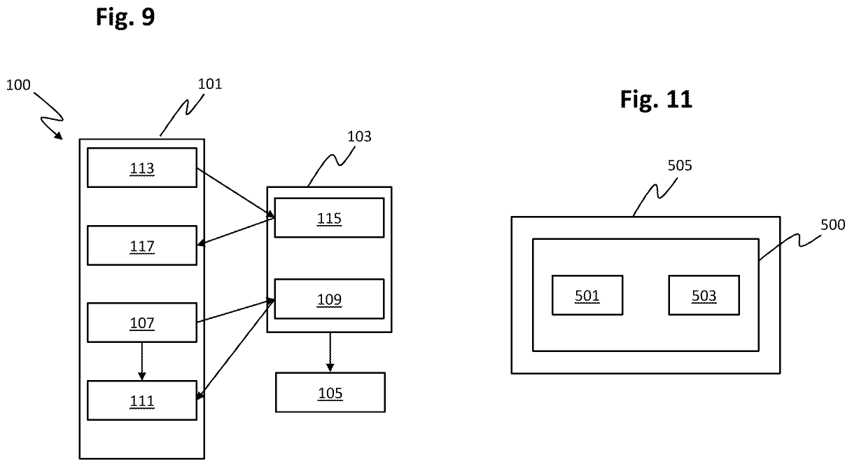

FIG. 9 shows another flowchart of the method 100 for generating a control program for controlling an automation system according to a further embodiment.

The embodiment of method 100 in FIG. 9 is based on the embodiment in FIG. 8 and comprises all the method steps described therein. Insofar as these remain unchanged in the following embodiment, a renewed detailed description is dispensed with.

In the embodiment shown, the diagram generating step 101 further comprises a reading step 113. In the reading step 113, a control program programmed in the graphical programming language ladder diagram LD is read in. The control program may in this context be represented, for example, in the textual representation of the graphical diagrams 200 or the data flow graphs 300 shown for FIGS. 1A-1C.

The graph generating step 103 further includes a second graph generating step 115. In the second graph generating step 115, a corresponding data flow graph 300 is generated based on information from the control program read in the reading step 113.

The diagram generating step 101 further comprises a displaying step 117. In the displaying step 117, a corresponding graphical diagram 200 is generated based on the data flow graph 300 generated in the second graph generating step 115.

Thus, by reading in a corresponding pre-existing control program, a corresponding data flow graph 300 may be generated based on the information of the read-in control program, and a corresponding graphical diagram 200 may be generated based on the information of the generated data flow graph 300 and displayed in a corresponding graphical programming tool.

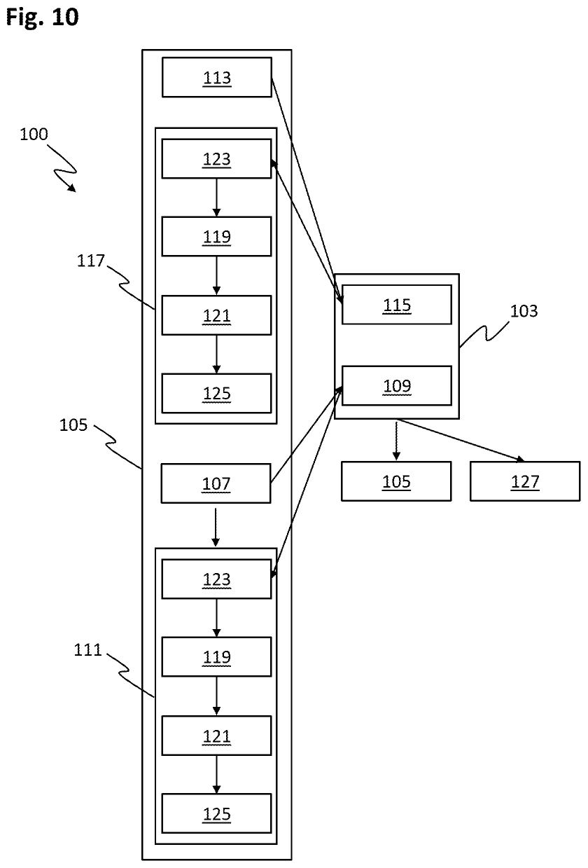

FIG. 10 shows a further flowchart of the method 100 for generating a control program for controlling an automation system according to a further embodiment.

The embodiment shown in FIG. 10 is based on the embodiment in FIG. 9 and comprises all the method steps shown there. Insofar as these remain unchanged in the following embodiment, a renewed detailed description is dispensed with.

In the embodiment shown, the graphical programming step 111 and the displaying step 117 comprise a plurality of method steps 119 to 125, with the aid of which a generation of the corresponding graphical diagrams 200 based on the data flow graphs 300 generated in the graph generating step 103 is described.

In a sorting step 123, the nodes 301 of the generated data flow graph 300 and the corresponding elements 201 of the respective graphical diagram 200 are first sorted topologically including a depth determination. By topologically sorting the nodes 301 of the data flow graph 300 and the corresponding elements 201 of the graphical diagram 200, an order is determined for both the nodes 301 and the elements 201 and an allocation to columns of the array 400 is determined. Similarly, the elements 201 of the graphical diagram 200 are ordered according to their distance from the left voltage rail L.

Subsequently, in a first arranging step 119, the nodes 301 of the data flow graph 300 are converted into elements 201 of the graphical diagram 200 and the elements 201 are arranged in a two-dimensional array 400.

In a second arranging step 121, the directed edges 303 of the data flow graph 300 are converted into corresponding connecting lines 203 between elements 201 of the graphical diagram 200 and arranged in the two-dimensional array 400 between the respective elements 201. In this case, the connecting lines 203 comprise exclusively horizontal and vertical components 205, 207, respectively. In this case, the two-dimensional array 400 may be embodied as a matrix array having a plurality of plot units 401, wherein each element 201 is arranged in a separate plot unit 401, and wherein the connecting lines 203 are arranged at least partially along the separating lines 403 between the plot units 401.

The arrangement of the elements 201 or connecting lines 203 of the graphical diagram 200 in the two-dimensional array 400 may be carried out in this regard in accordance with the example shown in graphical depiction D of FIG. 6D. The connecting lines 203 may include the indicated horizontal input and starting components 209, 217, the first and second vertical components 211, 215, and the horizontal center component 213. According to the embodiments shown in FIGS. 6A-6E, the respective components of the connecting lines 203 may be arranged on each of the vertical and horizontal separating lines 403 of the two-dimensional array 400, such that each horizontal center component 213 is arranged on an exclusive horizontal separating line 403.

In an optimizing step 125, the array 400 of the elements 201 and/or the connecting lines 203 of the graphical diagram 200 may be optimized using a suitable optimizing algorithm. For this purpose, lengths of connecting lines 203 and/or distances between elements 201 may be minimized. As an alternative or in addition, intersections of a plurality of connecting lines 203 may be avoided. In particular, the optimization may be optimized according to the example shown for the graphical depiction E of FIG. 6E, in that connecting lines 203, which interconnect elements 201 arranged at a height within the two-dimensional array 400, are embodied by rectilinear horizontal components 205. Here, in particular, the start and end points of a connecting line 203 are arranged at a height. Neither an element 201 nor a further edge 203 is arranged between the start and end points of a connecting line 203. Furthermore, the lengths of the respective connecting lines 203 may be reduced by reducing unnecessary horizontal or vertical components. By optimizing the arrangement 400 of the elements 201 or the connecting lines 203, a clear representation of the graphical diagram 200 may be achieved.

For example, the optimizing algorithm may include a prior art algorithm for solving a coloring problem.

In the embodiment shown, the method 100 further comprises a storing step 127. In the storing step 127, the data flow graph 300 may be stored in a text representation and/or the executable version of the control program may be stored in a corresponding execution file. The text representation of the data flow graph 300 may be stored in this case in a corresponding text file in accordance with the text representation executed with respect to FIGS. 1A-1C.

FIG. 11 shows a schematic diagram of a programming tool 500 according to an embodiment.

In the embodiment shown, the programming tool 500 includes a graphical editor unit 501 and a translating unit 503. The graphical programming tool 500 is operable on a data processing unit 505, which is, for example, a desktop computer, a laptop, or a cloud server.

The graphical editor unit 501 enables a user to generate graphical diagrams 200 according to corresponding graphical programming requests that satisfy the requirements and rules of the programming language ladder diagram LD. The translating unit 503 is further set up to translate the graphical programming requests or the corresponding graphical diagrams 200 into associated representations in the form of data flow graphs 300 according to the method 100 of the application. Furthermore, the translating unit 503 is arranged to transfer the correspondingly created data flow graphs 300 or the information content of the graph to the editor unit 501 so that a corresponding graphical representation or graphical diagram may be created by the editor unit 501. Furthermore, the translating unit 503 may be arranged to generate corresponding executable versions of a control program based on the generated data flow graphs 300. Furthermore, the translating unit 503 is set up to store the generated data flow graphs 300 in textual representation.

This invention has been described with respect to exemplary examples. It is understood that changes can be made and equivalents can be substituted to adapt these disclosures to different materials and situations, while remaining with the scope of the invention. The invention is thus not limited to the particular examples that are disclosed, but encompasses all the examples that fall within the scope of the claims.

TABLE 1
List of reference numerals

| | |
|---|---|
| 100 | method |
| 101 | diagram generating step |
| 103 | graph generating step |
| 105 | program generating step |
| 107 | receiving step |
| 109 | programming step |
| 111 | graphical programming step |
| 113 | reading step |
| 115 | second graph generating step |
| 117 | representing step |
| 119 | first arranging step |
| 121 | second arranging step |
| 123 | sorting step |
| 125 | optiming step |
| 127 | storing step |
| 200 | graphical diagram |
| 201 | element |
| 203 | connecting line |
| 205 | horizontal component |
| 207 | vetical component |
| 209 | horizontal starting component |
| 211 | first vertical component |
| 213 | horizontal center component |
| 215 | second vertical component |
| 217 | horizontal input component |
| 300 | data flow graph |
| 301 | node |
| 303 | edge |
| 305 | start node |
| 307 | end node |
| 308 | first node |
| 309 | second node |
| 310 | third node |
| 311 | fourth node |
| 312 | fifth node |
| 313 | first edge |
| 314 | second edge |
| 315 | third edge |
| 316 | fourth edge |
| 317 | fifth edge |
| 318 | sixth edge |
| 319 | seventh edge |
| 320 | eighth edge |
| 321 | ninth edge |
| 400 | two-dimensional array |
| 401 | plot unit |
| 403 | separating line |
| 500 | programmable tool |
| 501 | graphic editor unit |
| 503 | translating unit |
| 505 | data processing unit |

TABLE 2
List of reference symbols

| | | | |
|---|---|---|---|
| a | first input | x | first output |
| b | second input | y | second output |
| c | third input | L | left voltage rail |
| SEQ1 | first sequence | R | right voltage rail |
| SEQ2 | second sequence | E1 | first contact |
| SEQ3 | third sequence | E2 | second contact |
| ALT1 | first alternative | E3 | third contact |
| ALT2 | second alternative | A1 | first coil |
| ALT3 | third alternative | A2 | second coil |
| FB1 | first functional block instance | A3 | third coil |
| FB2 | second functional block instance | CALC | functional block |

1. A method for generating a control program for controlling an automation system, the method comprising:
generating a graphical diagram of the control program according to the Ladder Diagram LD graphical programming language for Programmable Logic Controllers in a diagram generating step;
generating a data flow graph as a representation of the graphical diagram in a graph generating step, wherein elements of the graphical diagram are represented as nodes and connecting lines between elements of the graphical diagram are represented as edges of the data flow graph; and
generating a version of the control program executable by a programmable logic controller based on the data flow graph in a program generating step.

2. The method according to claim 1, wherein the diagram generating step comprises:
receiving graphical programming requests according to the graphical programming language ladder diagram LD in a receiving step, wherein the graphical programming requests comprise adding and/or removing and/or rearranging elements and/or connecting lines of the graphical diagram; wherein the graph generating step comprises:
modifying the data flow graph by adding and/or removing and/or rearranging nodes and/or edges of the data flow graph according to the programming requests in a programming step; and wherein the graph generating step comprises:
adding and/or removing and/or rearranging elements and/or connecting lines within the graphical diagram based on the modifications to the data flow graph and according to the graphical programming requests in a graphical programming step.

3. The method according to claim 1, wherein the diagram generating step comprises:
reading in a control program programmed in the graphical programming language ladder diagram LD in a reading step; wherein the graph generating step comprises:
generating a data flow graph based on the information of the read-in control program in a second graph generating step; and wherein the diagram generating step comprises:
generating the graphical diagram based on the information of the data flow graph in a displaying step.

4. The method according to claim 2, wherein the graphical programming step and/or the displaying step comprise:
converting the nodes of the data flow graph into elements of the graphical diagram and arranging the elements in a two-dimensional array in a first arranging step;
converting the edges of the data flow graph into connecting lines between elements of the graphical diagram and arranging the connecting lines between the elements of the graphical diagram in a second arranging step, each connecting line comprising exclusively horizontal components and/or vertical components and connecting exclusively two elements.

5. The method according to claim 4, wherein the two-dimensional array is configured as a matrix array having a plurality of plot units, wherein each element is arranged in a plot unit, and wherein the connecting lines are arranged at least partially along separating lines between plot units.

6. The method according to claim 1, wherein the data flow graph is configured as an acyclic graph and comprises a start node and an end node.

7. The method according to claim 6, wherein the graphical programming step and/or the displaying step comprise:
topologically sorting the nodes of the data flow graph and the corresponding elements of the respective graphical diagram in a sorting step, wherein in the topological sorting an order of the nodes of the data flow graph and the corresponding elements of the graphical diagram is determined, and wherein the order corresponds to a distance of each node from the start node; and
arranging the elements of the graphical diagram according to the order of topological sorting in the first arranging step.

8. The method according to claim 2, wherein the graphical programming step and/or the displaying step comprise:
optimizing the arrangement of the elements and/or the connecting lines of the graphical diagram with the aid of an optimizing algorithm in an optimizing step, wherein the optimizing comprises minimizing lengths of the connecting lines and/or minimizing distances of elements and/or avoiding intersections of a plurality of connecting lines.

9. The method according to claim 1, wherein edges of the data flow graph are configured as directed edges, and wherein a direction of an edge between two nodes of the data flow graph represents a current flow between the elements of the graphical diagram represented by the nodes.

10. The method according to claim 1, wherein elements of the graphical diagram comprise voltage rails and/or contacts and/or coils and/or functional block instances and/or functional blocks and/or further elements defined according to the programming language ladder diagram LD.

11. The method according to claim 1, further comprising:
storing the data flow graph in a text representation and/or storing the executable version of the control program in an executing file in a storing step.

12. A programming tool for generating a control program for controlling an automation system, the programming tool comprising a graphical editor unit and a translating unit and being configured to carry out the method according to claim 1.

13. A method for controlling an automation system by carrying out a control program, wherein the control program is generated by the method for generating a control program for controlling an automation system according to claim 1.
